(19) United States
(12) Patent Application Publication
(10) Pub. No.: US 2026/0295742 A1
(43) Pub. Date: Oct. 1, 2026

(54) ADJUSTABLE STOP BLOCK

(71) Applicant: SUPER POWER TOOLS CO., LTD., Taichung City (TW)

(72) Inventor: Yu-Chun LIU, Taichung City (TW)

(21) Appl. No.: 19/094,220

(22) Filed: Mar. 28, 2025

(51) Int. Cl. B23Q 1/25

(52) U.S. Cl. CPC B23Q 1/25

(57) ABSTRACT

An adjustable stop block is disclosed, including a housing, a mounting mechanism, an adjustment mechanism, a stop arm, and a retaining pin. The housing forms an internal cavity extending to both ends. The mounting mechanism is mounted on the housing for securing the housing on a guide rail or a workbench. The adjustment mechanism includes a lead screw housed within the internal cavity, with the lead screw extending to the exterior of the housing and pivotally connected to the stop arm. The stop arm extends a stop flange configured to obstruct a moving workpiece. A resilient retaining pin is threaded into the housing and presses against the lead screw. The retaining pin restricts the lead screw from rotating and mitigates the displacement of the stop flange caused by the workpiece.

### FIELD OF THE INVENTION

The present invention relates to a tool used in cutting operations, in particular an adjustable stop block designed to enhance precision in machining tasks.

### BACKGROUND OF THE INVENTION

Machining tools such as circular saws and milling machines used to cut wooden workpieces are typically equipped with a workbench. The workpiece to be cut is positioned on the workbench and driven towards a rotating circular saw blade or milling cutter. The cutting edge of the tool engages the workpiece to make the cut.

Optionally, the workbench can be fitted with a guide rail with an upright guide face. The workpiece is placed on the workbench with one side against the guide face and then advanced towards the tool. The guide face directs the workpiece along a predetermined path towards the tool, facilitating accurate straight cuts.

A conventional stop block is affixed to the guide rail. This stop block comprises a housing, an adjustment mechanism, and a stop arm. The housing is connected to the guide rail and secures the stop block in place. The adjustment mechanism is integrated into the housing, and the stop arm is rotatably linked to the adjustment mechanism. The stop arm can be rotated as required to align with the guide face. As the workpiece moves along the guide face, the stop arm obstructs the workpiece, thereby controlling the size of the cut made by the tool. This ensures consistent cutting dimensions across multiple workpieces.

Once the housing is secured to the guide rail, the adjustment mechanism can be operated to reposition the stop arm along the path of the workpiece, ensuring the accuracy of the cut.

The adjustment mechanism facilitates linear movement of the stop arm and provides support to withstand the forces exerted by the workpiece. However, in practice, when the workpiece contacts the stop arm, the point of force application often deviates from the direction of support provided by the adjustment mechanism. This misalignment creates a torque on the stop arm, potentially causing displacement along the path of the workpiece.

### SUMMARY OF THE INVENTION

The main purpose of the present invention is to provide an adjustable stop block that addresses the aforementioned issues. The invention employs the following technical solution.

An adjustable stop block includes a housing having a proximal end and a distal end positioned opposite each other along a first axis. The interior of the housing contains an internal cavity extending along the first axis to both ends;

A mounting mechanism is mounted on the housing along a second axis, orthogonal to the first axis, for securing the housing to a guide rail or a workbench of a machining tool.

An adjustment mechanism is provided, which includes a drive screw and a lead screw. The drive screw is rotatably housed within the internal cavity and extends along the first axis through the proximal end to the exterior of the housing. The lead screw is axially movable within the internal cavity and extends along the first axis through the distal end to the exterior. The lead screw is fitted with two spacer washers and secured with a nut. The spacers are spaced along the first axis between the nut and the distal end. The drive screw is threaded onto the lead screw, enabling it to drive the lead screw along the first axis.

A stop is arm pivotally attached to the lead screw, with the spacer washers clamping the stop arm along the first axis, enabling the stop arm to rotate about the first axis relative to the lead screw, wherein the lead screw drives the stop arm to move along the first axis, and the stop arm extends a stop flange configured to obstruct a workpiece moving along the first axis.

The housing includes a threaded aperture connecting the internal cavity to a side of the housing. The lead screw forms a longitudinal slot along its outer circumference, aligned with the first axis. A resilient retaining pin is threaded into the aperture, with one end engaging the slot and pressing against the lead screw.

The resilient retaining pin, upon engaging the slot and pressing against the lead screw, prevents the lead screw from rotating and induces a slight offset, minimizing the displacement of the stop flange caused by the workpiece. This configuration also restricts arbitrary movement of the lead screw along the first axis.

### BRIEF DESCRIPTION OF DRAWINGS

FIG. 1 is a perspective view of a preferred embodiment of the present invention.

FIG. 2 is another perspective view of the preferred embodiment of the present invention.

FIG. 3 is yet another perspective view of the preferred embodiment of the present invention

FIG. 4 is an exploded perspective view of the preferred embodiment of the present invention.

FIG. 5 is a cross-sectional view of the preferred embodiment of the present invention.

FIG. 6 is a sectional view taken along line 6-6 of FIG. 5.

FIG. 7 is a sectional view taken along line 7-7 of FIG. 5.

FIG. 8 is a perspective schematic view of the preferred embodiment of the present invention in use.

### DETAILED DESCRIPTION OF THE INVENTION

The drawings illustrate a preferred embodiment of the adjustable stop block according to the present invention. This embodiment is illustrative and is not intended to limit the scope of the patent application.

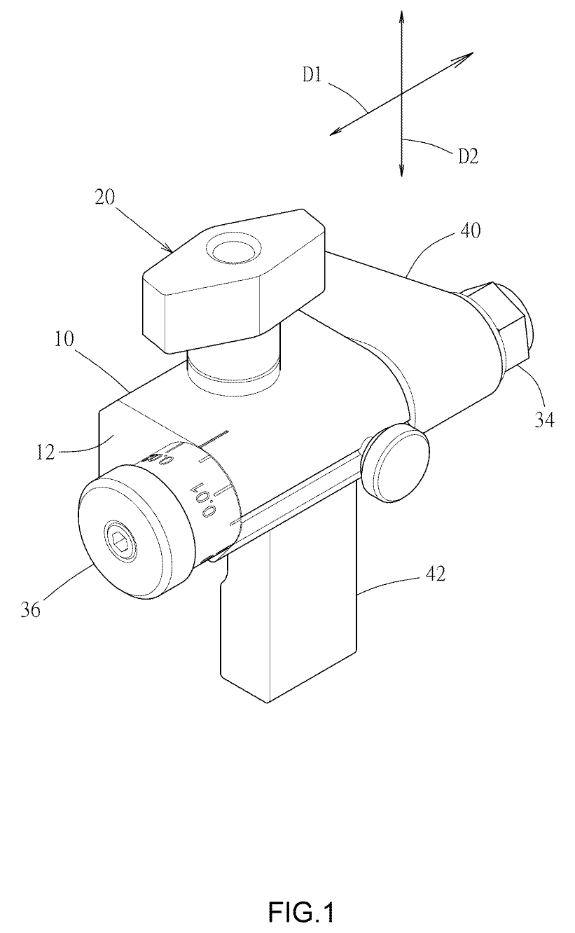

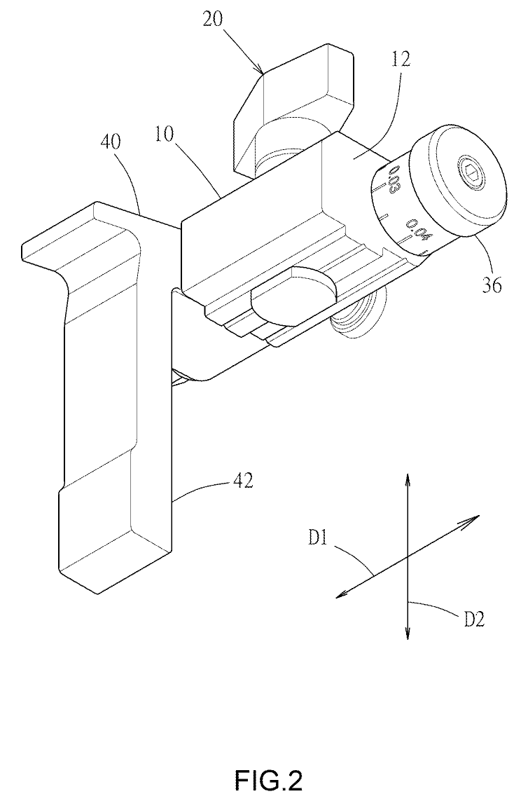

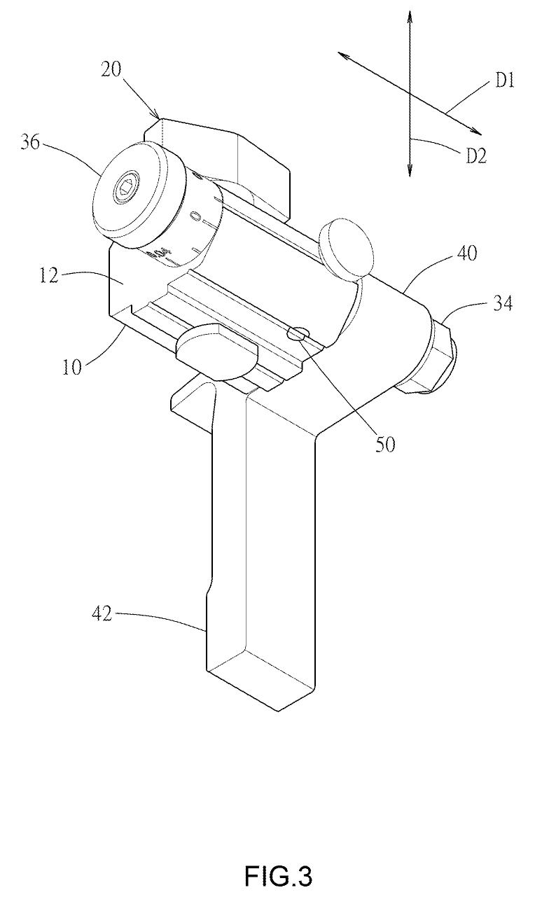

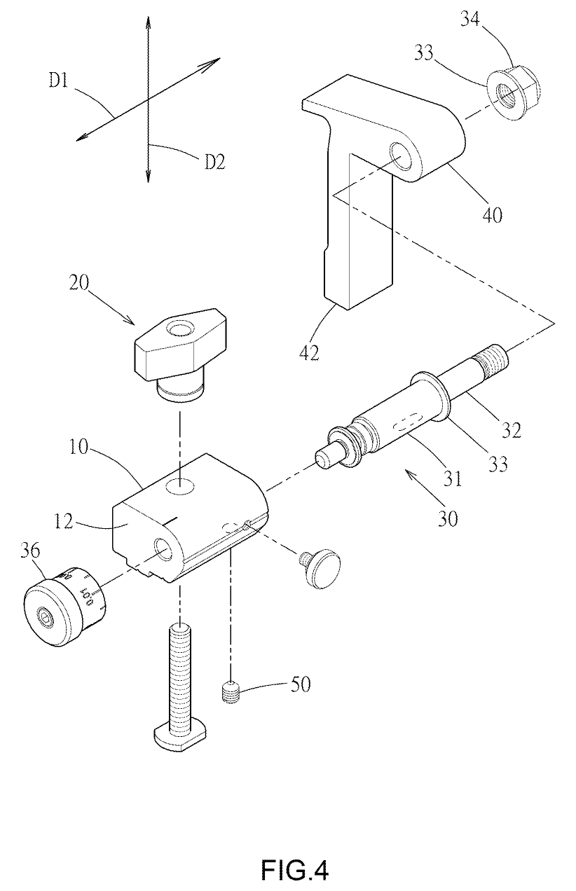

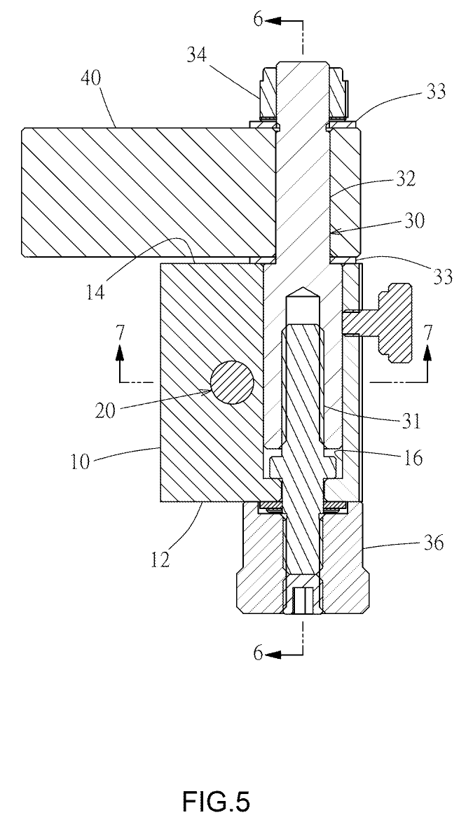

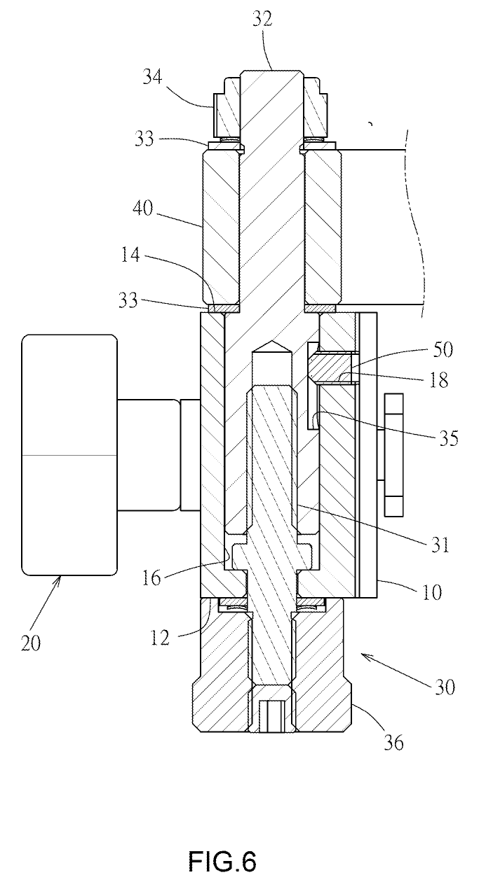

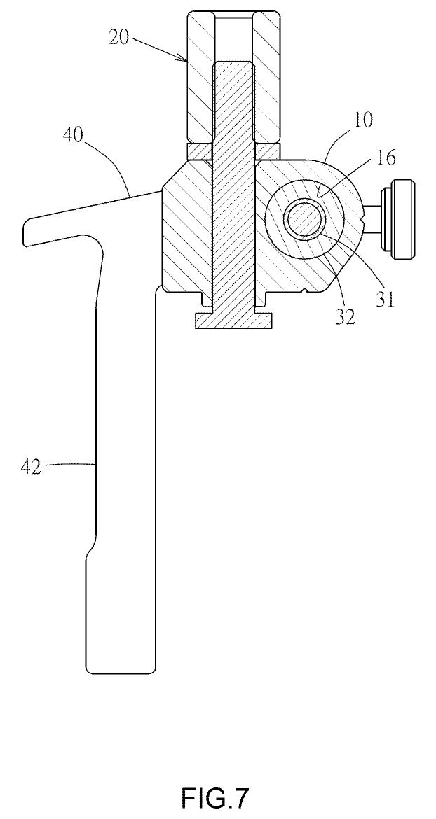

As illustrated in FIGS. 1 to 8, the preferred embodiment comprises a housing 10, a mounting mechanism 20, an adjustment mechanism 30, and a stop arm 40. The housing 10 has a proximal end 12 and a distal end 14 aligned along a first axis D1. The interior of the housing 10 contains an internal cavity 16 extending along the first axis D1 to both ends.

The mounting mechanism 20 is mounted on the housing 10 along a second axis D2, orthogonal to the first axis D1, for affixing the housing 10 to a guide rail 92 or a workbench 94 of a machining tool. The mounting mechanism 20 and its configuration relative to the housing 10 are conventional and will not be described in detail here.

The adjustment mechanism 30 includes a drive screw 31 and a lead screw 32. The drive screw 31 is rotatably housed within the internal cavity 16 and extends along the first axis D1 through the proximal end 12 to the exterior. The lead screw 32 is axially movable within the internal cavity 16 and extends along the first axis D1 through the distal end 14 to the exterior. The lead screw 32 is fitted with two spacer washers 33 and secured with a nut 34. The washers 33 are spaced along the first axis D1 between the nut 34 and the distal end 14. The drive screw 31 is threaded onto the lead screw 32, enabling it to drive the lead screw 32 to move along the first axis D1.

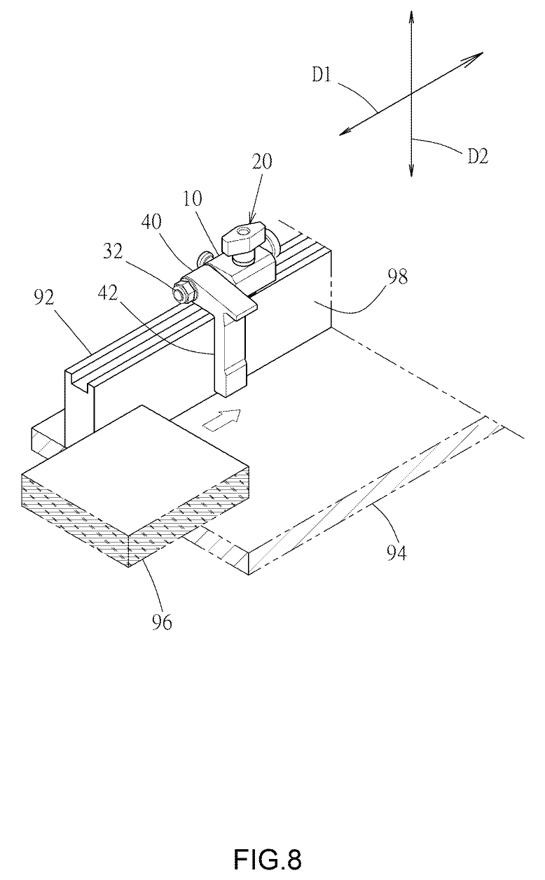

The lead screw 32 is pivotally connected to the stop arm 40, with the spacer washers 33 clamping the stop arm 40 along the first axis D1, allowing it to rotate about the first axis D1 relative to the lead screw 32. When the drive screw 31 drives the lead screw 32, the lead screw 32 moves the stop arm 40 along the first axis D1. The stop arm 40 extends a stop flange 42. As illustrated in FIG. 8, a workpiece 96 is placed on the workbench 94 with one side against a guide face 98 of the guide rail 92. The stop flange 42 obstructs the movement of the workpiece 96 along the first axis D1 under the guidance of the guide face 98.

The housing 10 includes a threaded aperture 18 connecting the internal cavity 16 to a side of the housing 10. The lead screw 32 forms a longitudinal slot 35 along its outer circumference aligned with the first axis D1. A resilient retaining pin 50 is threaded into the aperture 18, with one end engaging the slot 35 and pressing against the lead screw 32, thereby enhancing the positional accuracy of the stop arm 40 along the first axis D1.

The resilient retaining pin 50, upon engaging the slot 35 and pressing against the lead screw 32, prevents the lead screw 32 from rotating. To facilitate assembly, the lead screw 32 and the internal cavity 16 are typically designed with a diameter tolerance, and the drive screw 31 and the lead screw 32 are configured with a threaded connection tolerance. When the retaining pin 50 presses against the lead screw 32, it induces a slight offset, which reduces the displacement of the stop flange 42 caused by the workpiece 96. Due to its resilient material, the retaining pin 50 creates friction with the lead screw 32, thereby restricting arbitrary movement along the first axis D1. This configuration enables fine adjustment of the lead screw 32 along the first axis D1 through the adjustment mechanism 30.

The retaining pin 50 is positioned along the second axis D2 within the threaded aperture 18 and presses against the lead screw 32. As illustrated in FIG. 8, the stop flange 42 obstructs the movement of the workpiece 96 along the first axis D1. The force exerted by the workpiece 96 on the stop flange 42 along the first axis D1 is transmitted through the stop arm 40 along the second axis D2 to the lead screw 32. The retaining pin 50, which presses against the lead screw 32 along the second axis D2, can mitigate the impact of the workpiece 96 on the lead screw 32 through the stop arm 40.

The adjustment mechanism 30 further includes a control knob 36. The drive screw 31 extends along the first axis D1 through the proximal end 12 to the exterior of the housing 10 and is connected to the control knob 36. Rotating the control knob 36 drives the lead screw 32 to move along the first axis D1 through the drive screw 31.

1. An adjustable stop block comprising:
a housing having a proximal end and a distal end, with the proximal end and the distal end opposing each other along a first axis, wherein the interior of the housing contains an internal cavity that extends along the first axis to the proximal end and the distal end;
a mounting mechanism mounted on the housing along a second axis, orthogonal to the first axis, for securing the housing to a guide rail or a workbench of a machining tool;
an adjustment mechanism including a drive screw and a lead screw, wherein the drive screw is rotatably housed within the internal cavity and extends along the first axis through the proximal end to the exterior of the housing, and the lead screw is axially movable within the internal cavity and extends along the first axis through the distal end to the exterior of the housing, wherein the lead screw is fitted with two spacer washers and secured with a nut, with the spacer washers spaced along the first axis between the nut and the distal end, and wherein the drive screw is threaded onto the lead screw, thereby driving the lead screw to move along the first axis; and
a stop arm pivotally attached to the lead screw, with the spacer washers clamping the stop arm along the first axis, enabling the stop arm to rotate about the first axis relative to the lead screw, and wherein the lead screw drives the stop arm to move along the first axis, and the stop arm extends a stop flange configured to obstruct a workpiece moving along the first axis;
wherein the housing includes a threaded aperture connecting the internal cavity to a side of the housing, and the lead screw forms a longitudinal slot along its outer circumference aligned with the first axis, with a resilient retaining pin threaded into the threaded aperture, wherein one end of the retaining pin engages the longitudinal slot and presses against the lead screw.

2. The adjustable stop block of claim 1, wherein the retaining pin is positioned along the second axis within the threaded aperture and presses against the lead screw.

3. The adjustable stop block of claim 1, wherein the adjustment mechanism further includes a control knob, and wherein the drive screw extends along the first axis through the proximal end to the exterior of the housing and is connected to the control knob, such that rotating the control knob drives the lead screw to move along the first axis through the drive rod.
